(19) United States
(12) Patent Application Publication
(10) Pub. No.: US 2007/0275270 A1
(43) Pub. Date: Nov. 29, 2007

(54) INFORMATION MEDIUM

(75) Inventors: Kazuhiro HATTORI, Tokyo (JP); Kazuya SHIMAKAWA, Tokyo (JP)

Correspondence Address: GREENBLUM & BERNSTEIN, P.L.C., 1950 ROLAND CLARKE PLACE, RESTON, VA, 20191, US

(73) Assignee: TDK CORPORATION, Tokyo (JP)

(21) Appl. No.: 11/753,028

(22) Filed: May 24, 2007

(30) Foreign Application Priority Data
May 26, 2006 (JP) 2006-146168

(51) Int. Cl. G11B 5/65

(52) U.S. Cl. 428/833; 428/835.5; 428/835.6

(57) ABSTRACT

An information medium which is capable of maintaining the protection capability by a lubricant for a long term. An information medium has a recording area and a non-recording area disposed on at least one surface of a disk-shaped base plate. The information medium is configured such that a lubricant exists on the one surface of the disk-shaped base plate. The recording area is configured such that a protective film formed of DLC exists above the recording layer. At least a surface-side portion of the non-recording area is formed of a resin material having a higher bonding ratio with respect to the lubricant than that of DLC.

### BACKGROUND OF THE INVENTION

1. Field of the Invention

The present invention relates to an information medium having a recording area and a non-recording area arranged on at least one surface of a substrate.

2. Description of the Related Art

As an information medium of this kind, there has been disclosed a magnetic recording medium (medium for a “magnetic disk drive: hard disk drive”) in Japanese Laid-Open Patent Publication (Kokai) No. 2000-195042, which has a recording area and a non-recording area arranged on one surface of a disk substrate. When the magnetic recording medium is manufactured, first, concentric grooves are formed in the disk substrate made of glass by an etching method. Then, a base layer (chrome), a magnetic layer (alloy of cobalt, chrome, platinum, and tantalum), a first non-magnetic film (chrome), and a second non-magnetic film (silicon oxide) are sequentially formed on the groove-formed surface of the disk substrate in the mentioned order. Subsequently, a polishing process by the CMP (chemical mechanical polishing) method is carried out until the first non-magnetic film is exposed. Thus, a pattern having recording areas (areas where the first non-magnetic film is exposed) and non-recording areas (areas the uppermost layer of which is formed of the second non-magnetic film) is formed (disposed) on one surface of the disk substrate. After that, a third non-magnetic film (amorphous carbon) is formed on the polished surface, whereby the magnetic recording medium is completed.

From the study of the conventional magnetic recording medium, the present inventors found out the following problems: In the conventional magnetic recording medium, the third non-magnetic film is formed in a manner covering the whole area of the magnetic recording medium. In this case, to prevent a magnetic head and the information medium from being damaged by contact therebetween during the recording/reproducing process, this kind of information medium is configured such that a lubricant is applied to the surface of the information medium. Further, to meet recent demands for high-density recording and high-speed recording/reproducing of a recording and reproducing device, in the technical field of recording and reproducing, it is attempted to increase the rotational speed of the information medium, and head flying height with respect to the information medium tends to be reduced so as to reduce a spacing loss caused by a gap between the magnetic head and the information medium.

However, in the conventional magnetic recording medium over the whole area of which is formed the third non-magnetic film, troubles that the lubricant is scattered around the magnetic recording medium, or is transferred from the surface of the magnetic recording medium to the bottom surface of the magnetic head (slider) are liable to occur during high-speed rotation of the medium, since a bonding ratio of amorphous carbon, which forms the third non-magnetic film, with respect to the lubricant is low, i.e., that amorphous carbon is low in capability of holding the lubricant. Therefore, the conventional magnetic recording medium suffers from the problem that due to the scattering and transfer of the lubricant, it is difficult to maintain the capability of protecting both the magnetic head and the magnetic recording medium for a long term.

### SUMMARY OF THE INVENTION

The present invention has been made in view of these problems, and a main object of the present invention is to provide an information medium which is capable of maintaining the protection capability by a lubricant for a long term.

An information medium according to the present invention is configured such that a recording area and a non-recording area are arranged on at least one surface of a substrate, and a lubricant exists on the one surface, wherein the recording area is configured such that a protective film formed of a protective film-forming material exists above a recording area-forming material, and wherein at least a surface-side portion of the non-recording area is formed of a non-recording area-forming material having a bonding ratio with respect to the lubricant higher than that of the protective film-forming material. It should be noted that throughout the specification, the term “recording area” is intended to mean an area which is configured to readably hold a recorded signal (that is, an area having a capability of readably holding a signal). Further, throughout the present specification, the term “non-recording area” is intended to mean an area which is configured to have a lower capability of readably holding a signal than that of the recording area, or an area configured such that it does not substantially have the capability. Further, throughout the present specification, the term “bonding ratio” is intended to mean a ratio, in percentage, of an average thickness of a lubricant layer which is formed by applying a lubricant and subjected to a predetermined washing process to an average thickness of the lubricant layer immediately after application of the lubricant. That is, a state where the bonding ratio is high means a state where the adhesion of the lubricant is high (a holding force for holding the lubricant is large).

According to this information medium, the recording area is configured such that the protective film formed of the protective film-forming material exists above the recording area-forming material, and at least a surface-side portion of the non-recording area is formed of the non-recording area-forming material having a bonding ratio with respect to the lubricant higher than that of the protective film-forming material. Therefore, compared with the conventional magnetic recording medium over the whole area of which is formed the third non-magnetic film (amorphous carbon) having a lower bonding ratio with respect to the lubricant, it is possible to enhance the bonding ratio per predetermined area of the information medium with respect to the lubricant, since there exists an area in which a layer of the non-recording area-forming material having a higher bonding ratio with respect to the lubricant is exposed at the surface thereof. Therefore, the adhesion of the lubricant (the holding force for holding the lubricant) is sufficiently enhanced over the whole information medium, so that when the information medium is rotated at a high speed, it is possible to prevent the lubricant from being lost by being scattered around the information medium, or from being lost by being transferred from the surface of the information medium to the bottom surface of a recording and reproducing mechanism (e.g., a magnetic head) in a recording and reproducing device incorporating the information medium. This makes it possible to maintain the capability of protecting both the information medium and the recording and reproducing mechanism for a long term.

The protective film-forming material may be mainly composed of carbon, and the non-recording area-forming material may be formed of a resin material. It should be noted that throughout the present specification, the term a state “mainly composed of carbon” is intended to mean a “state in which the atomic percent of carbon out of constituent elements of the protective film-forming material is equal to or more than 50%”. Accordingly, this state also contains a state in which all of the protective film-forming material is formed of carbon. With this configuration, it is possible to reliably protect a layer (recording layer) of the recording area-forming material for a long term by the protective film that is formed of a material mainly composed of carbon that has a sufficient hardness and a low aging rate, and cause a sufficient amount of the lubricant to adhere to an area (non-recording area) where a layer (resin layer) of the non-recording area-forming material formed of a resin material is formed which has a high bonding ratio with respect to the lubricant and can be easily machined. This makes it possible to protect both the information medium and the recording and reproducing mechanism from being damaged for a long term.

The non-recording area may be formed such that at least a level of a central portion thereof is lower than a level of the recording area. It should be noted that throughout the present specification, the term “central portion of the non-recording area” is intended to mean a “portion of a non-recording area located at an equal or approximately equal distance from two recording areas disposed on either side of the non-recording area (i.e., two recording areas that face each other with the non-recording area in between). With this configuration, it is possible to reliably prevent the surface of the non-recording area (layer of the non-recording area-forming material) which is not covered with the protective film, from being damaged by contact between the information medium and the recording and reproducing mechanism. Further, this makes it possible to properly store a sufficient amount of the lubricant in the non-recording area whose level is lower than that of the recording area (the surface of the protective film).

It should be noted that the present disclosure relates to the subject matter included in Japanese Patent Application No. 2006-146168 filed May 26, 2006, and all the disclosures therein are clearly incorporated herein by reference.

### BRIEF DESCRIPTION OF THE DRAWINGS

These and other objects and features of the present invention will be explained in more detail below with reference to the attached drawings, wherein:

FIG. 1 is a cross-sectional view of a magnetic disk;

FIG. 2 is a cross-sectional view of a workpiece with a concave/convex pattern formed thereon;

FIG. 3 is a cross-sectional view of the workpiece with the concave/convex pattern formed therein after completion of etching of a recording layer;

FIG. 4 is a cross-sectional view of the workpiece with a protective film formed in a manner covering the concave/convex pattern;

FIG. 5 is a cross-sectional view of the workpiece with a resin layer formed in a manner covering the concave/convex pattern (protective layer);

FIG. 6 is a cross-sectional view of the workpiece and a burnishing device in a state in which a planarizing process is being carried out on the resin layer;

FIG. 7 is a plan view of the workpiece and a burnishing device in a state in which a planarizing process is being carried out on the resin layer;

FIG. 8 is a cross-sectional view of the workpiece in a state where the planarizing process has been completed;

FIG. 9 is another cross-sectional view of the workpiece in the state where the planarizing process has been completed;

FIG. 10 is a cross-sectional view of another workpiece with a concave/convex pattern formed thereon;

FIG. 11 is a cross-sectional view of the FIG. 10 workpiece with a resin layer formed in a manner covering the concave/convex pattern;

FIG. 12 is a cross-sectional view of another magnetic disk;

FIG. 13 is an external perspective view of another burnishing device and the workpiece;

FIG. 14 is a bottom view of a burnishing head; and

FIG. 15 is a bottom view of another burnishing head.

### DESCRIPTION OF THE PREFERRED EMBODIMENTS

Hereinafter, the best mode of an information medium according to the present invention will be described with reference to the accompanying drawings.

First, a description will be given of the construction of a magnetic disk 1 which is an example of the information medium according to the present invention with reference to the drawings.

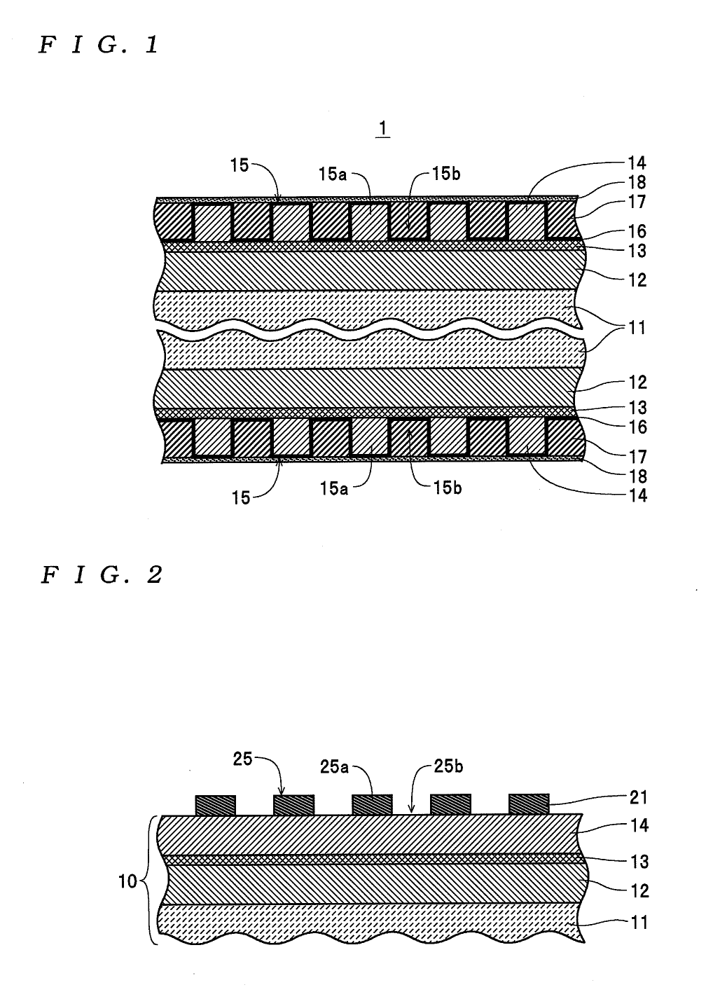

Referring to FIG. 1, the magnetic disk 1 is a discrete track-type magnetic recording medium (patterned medium), which is configured to have plural concentric or helical data recording tracks formed thereon such that the magnetic disk 1 is capable of recording data by a perpendicular recording method, and as described hereinafter, made using a workpiece 10 (an example of a substrate in the present invention) shown in FIG. 2. In this case, the workpiece 10 has a soft magnetic layer 12, an intermediate layer 13, and a recording layer (magnetic recording layer: an example of a layer of a “recording area-forming material”) 14 sequentially formed on each of the opposite surfaces of a disk-shaped base plate 11 thereof in the mentioned order. Further, when the magnetic disk 1 is made, a metal mask layer 21 for forming a concave/convex pattern 25 as a mask pattern, and a resist layer, not shown, for forming concave portions 25b in the metal mask layer 21 by etching the metal mask layer 21 are formed on the front and rear surfaces of the workpiece 10 by an etching process.

On the other hand, as shown in FIG. 1, the magnetic disk 1 has the soft magnetic layer 12, the intermediate layer 13, and the recording layer 14 sequentially formed on each of the opposite surfaces of the disk-shaped base plate 11 in the mentioned order. Further, the magnetic disk 1 has plural convex portions 15a (recording areas) as divided recording elements each having at least a protruding end thereof made of a magnetic material (recording layer 14) and plural concave portions 15b (non-recording areas), formed therewith (arranged therein) to form a concave/convex pattern which serves as a data track pattern or a servo pattern. It should be noted that when the information medium according to the present invention is a magnetic recording medium, such as the magnetic disk 1, the term “recording area” is intended to mean an area which is configured to readably hold a recorded magnetic signal (that is, an area having a capability of readably holding a magnetic signal), and the term “non-recording area” is intended to mean an area which is configured to have a lower capability of readably holding a magnetic signal than that of the recording area, or an area configured such that it does not substantially have the capability. More specifically, the term “non-recording area” of the magnetic recording medium is intended to mean an area which generates a smaller magnetic field than the recording area, in a state having a magnetic signal recorded thereon, or an area which generates substantially no magnetic field.

Further, the magnetic disk 1 has the concave/convex pattern 15 thereof covered with a protective film 16 formed of DLC (Diamond Like Carbon: an example of a “material mainly composed of carbon” as a “protective film-forming material” in the present invention). In this case, the bonding ratio of the protective film 16 formed of DLC with respect to a lubricant 18, described hereinafter, is set to 65%. It should be noted that an example of the lubricant 18, and a method of measuring the bonding ratio will be described in detail hereinafter. Further, the protective film 16 formed of DLC contains hydrogen and nitrogen as well as carbon, and such a state as well is included in a “state formed of a material mainly composed of carbon”. Furthermore, the protective film 16 can also be formed of a material formed substantially only by carbon, such as amorphous carbon.

Furthermore, in the magnetic disk 1, resin layers 17 are formed therein by embedding a resin material (an example of a “non-recording area-forming material” in the present invention), which is a non-magnetic material, in each concave portion 15b of the concave/convex pattern 15. In this case, in the magnetic disk 1, as described hereinafter, the resin material (resin layer 17) embedded in each concave portion 15b is formed such that the level of a central portion of the surface of the resin material is slightly lower than the level of the surface of the protective film 16 on the convex portions 15a. Further, ultraviolet-curing resins, such as an acrylic resin and an epoxy resin, can be used as the resin material. In this case, the bonding ratio of the resin layer 17 formed of an ultraviolet-curing resin with respect to the lubricant 18 is higher than the bonding ratio of the protective film 16 with respect to the lubricant 18, and is set to 90%, for example. It should be noted that various types of radiation-curing resin materials, such as electron ray-curing resin materials, thermosetting resin materials, and so forth can also be used in place of the ultraviolet-curing resin materials. Also when the resin layer 17 is formed using any of these resin materials, the bonding ratio of the formed resin layer 17 with respect to the lubricant 18 is sufficiently higher than the bonding ratio of the protective film 16 to the lubricant 18.

Further, the magnetic disk 1 has the surfaces thereof coated with the lubricant 18. In this case, although not particularly limited, fluorine-based lubricants, such as a perfluoropolyether-based lubricant, a tetrafluoroethylene oxide-based lubricant, and a hexafluoropropylene oxide-based lubricant, which are diluted with a solvent, can be used as the lubricant 18. More specifically, in the magnetic disk 1, there is used, for example, the lubricant 18 in which “Fomblin Z15” (available from Ausimont K.K.) is used as a lubricant (an example of the perfluoropolyether-based lubricant), and “Vertrel XF” (available from DU PONT-MITSUI FLUOROCHEMICALS COMPANY, LTD.) is used as a solvent; and in which the lubricant concentration is set to 0.05 wt %. It should be noted that although in FIG. 1 and FIG. 12, referred to hereinafter, for ease of understanding of the present invention, the lubricant 18 is shown to be uniformly applied to respective portions of the surface of the magnetic disk 1 such that the lubricant 18 forms a layer, actually, the lubricant 18 is considered to be scattered such that it has an island-like shape.

Next, a method of manufacturing the magnetic disk 1 will be described with reference to drawings.

First, as shown in FIG. 2, the concave/convex patterns 25 are formed on the respective recording layers 14 of the workpiece 10. More specifically, for example, a concave/convex pattern is formed on the above-mentioned resist layer formed on the workpiece 10, e.g., by an imprinting method. It should be noted that in the following description, for ease of understanding of the present invention, attention is paid to a single side of the workpiece 10 for description of the method of manufacturing the magnetic disk 1. In this case, a master disk (stamper), not shown, used during an imprinting process has plural concave portions formed in a manner corresponding to the respective convex portions 15a of the magnetic disk 1, and plural convex portions formed in a manner corresponding to the respective concave portions 15b of the magnetic disk 1. Therefore, by pressing the master disk against the resist layer and transferring the concave/convex pattern of the master disk to the resist layer, a concave/convex pattern, not shown, having plural convex portions corresponding to the respective convex portions 15a of the magnetic disk 1, and plural concave portions corresponding to the respective concave portions 15b of the magnetic disk 1 is formed on the metal mask layer 21.

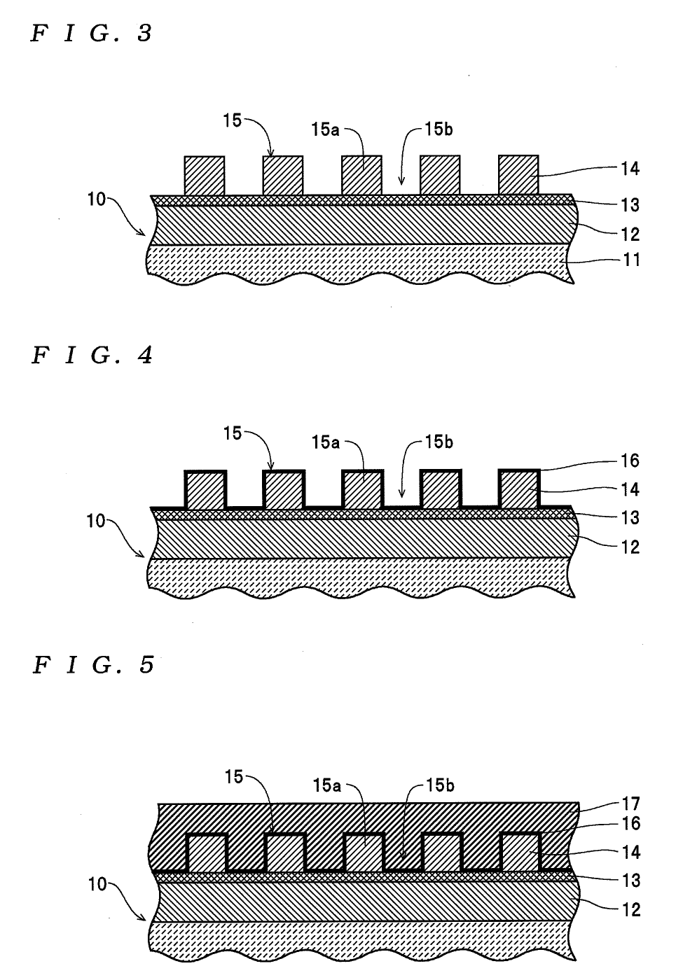

Then, an etching process is performed on the metal mask layer 21 using the above-described concave/convex pattern as a mask pattern, whereby the concave/convex pattern 25 is formed on the recording layer 14, as shown in FIG. 2. It should be noted that although the resist layer (residue) remains on each of the convex portions 25a of the concave/convex pattern 25 when the etching process on the metal mask layer 21 has been completed, description and illustration of the residue are omitted for ease of understanding of the present invention. Subsequently, after the recording layer 14 is etched using the concave/convex pattern 25 as a mask pattern, the metal mask layer 21 is eliminated by selective etching, whereby the concave/convex pattern 15 is formed in the recording layer 14, as shown in FIG. 3. In doing this, plural concave portions 15b having a depth reaching the intermediate layer 13 are formed in the workpiece 10 in a manner corresponding to the concave portions 25b of the concave/convex pattern 25. It should be noted that in FIG. 3, the depth of each concave portion 15b is illustrated by a depth different from an actual depth thereof for ease of understanding of the present invention.

Then, as shown in FIG. 4, the protective film 16 is formed in a manner covering at least the protruding end of each convex portion 15a of the concave/convex pattern 15 formed on the workpiece 10. In doing this, prior to a resin layer-forming process, described hereinafter, the protective film 16 is formed of DLC in a manner covering the surface formed with the concave/convex pattern 15 (in a manner covering the concave/convex pattern 15) in the workpiece 10. Subsequently, as shown in FIG. 5, the resin layer 17 is formed on the concave/convex pattern 15 covered with the protective film 16. More specifically, for example, an ultraviolet-curing resin material is applied by a spin coating method, on the surface formed with the concave/convex pattern 15 in the workpiece 10. This completes the resin layer-forming process, whereby the resin layer 17 whose thickness measured from the protruding end face of each convex portion 15a of the concave/convex pattern 15 (i.e., from the surface of the protective film 16) is approximately 5 nm to 20 nm is formed on the workpiece 10. It should be noted that although the concave/convex shape of the concave/convex pattern 15 sometimes appears on the surface of the resin layer 17 depending on the viscosity and amount of an applied resin material, whereby micro asperities are formed on the surface of the resin layer 17, in FIG. 4, the surface of the resin layer 17 (upper surface thereof, as viewed in FIG. 4) is illustrated as flat, for ease of understanding of the present invention.

Then, ultraviolet rays are irradiated onto the resin layer 17 of the workpiece 10, whereby the resin layer 17 is half cured. It should be noted that throughout the specification, the term “half cured” state of the resin layer 17 is intended to mean various states in which the resin material is lower in fluidity than when it is applied, and at the same time is not completely cured. More specifically, for example, by adjusting a time period over which ultraviolet rays are irradiated onto the resin layer 17, and the power of the irradiated ultraviolet rays, as required, the resin layer 17 is cured such that the fluidity of the resin material (resin layer 17) is made lower than that immediately after the resin material is applied by the spin coating method during the above-described resin layer-forming process, whereby the resin layer 17 is made hard enough to polish the surface thereof during a planarizing process, described hereinafter. It should be noted that when a thermosetting resin material is used for forming the resin layer 17, the fluidity of the resin material (resin layer 17) is lowered to a desired state by adjusting a time period over which heating process is carried out on the resin layer 17, and temperature at which the heating process is carried out, as required.

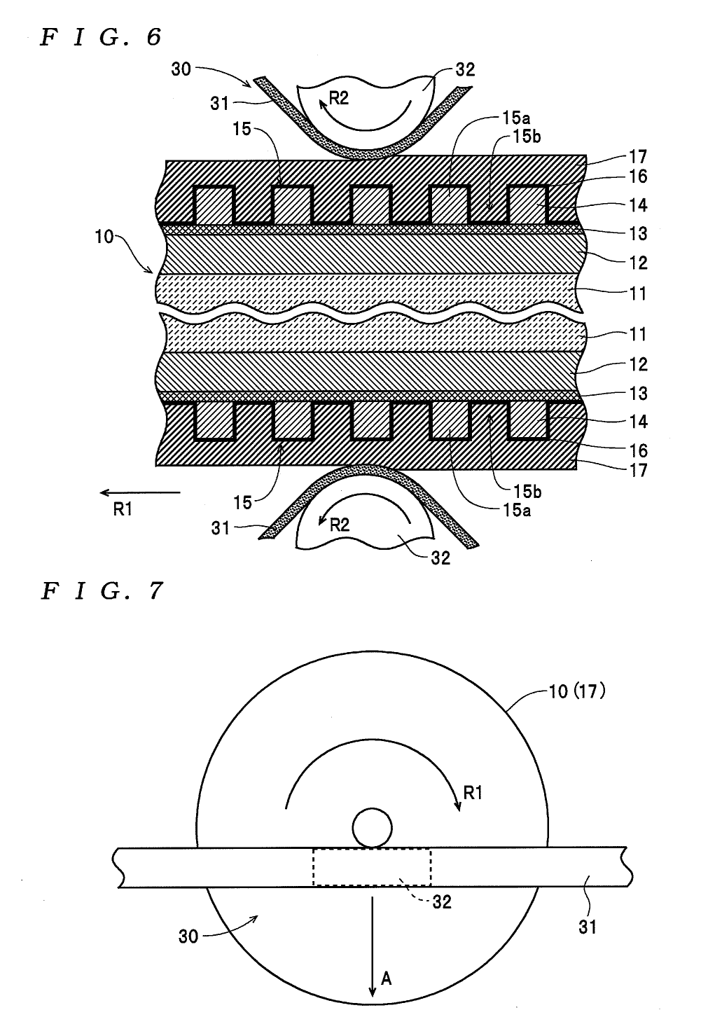

Next, the surface of the resin layer 17 half cured is polished to thereby planarize a surface (opposite surfaces, in the illustrated example) of the workpiece 10, on a side or sides formed with the concave/convex pattern 15 (execution of the planarizing process). In doing this, the surface of the resin layer 17 is polished e.g., by a burnishing device 30 shown in FIGS. 6 and 7. In this case, the burnishing device 30 includes burnishing tapes 31 for polishing the surfaces of a polishing object (resin layers 17 on the workpiece 10, in the illustrated example), a pair of rollers 32 for rubbing the burnishing tapes 31 against the polishing object, and a rotating mechanism, not shown, for rotating the polishing object (workpiece 10) in a direction indicated by an arrow R1.

The burnishing tape 31 (dry polishing member) has a support tape, for example, which has a width of approximately 10 mm and has one surface having an abrasive attached thereto. The rollers 32 press the surfaces of the burnishing tapes 31, having the abrasive attached thereto, against the respective surfaces of the opposite resin layers 17 with a predetermined load. In this case, The rollers 32 are continuously rotated in a direction indicated by an arrow R2 shown in FIG. 6 at a very low speed during execution of polishing of the resin layers 17, to thereby feed the burnishing tapes 31. Further, as shown in FIG. 7, each roller 32 is gradually moved by a moving mechanism, not shown, from a position where the roller 32 presses the burnishing tape 31 against a central portion of the workpiece 10 toward an outer periphery of the workpiece 10 in a direction indicated by an arrow A, whereby the roller 32 presses the burnishing tape 31 against the workpiece 10 over the whole area from the central portion of the workpiece 10 to the outer periphery thereof.

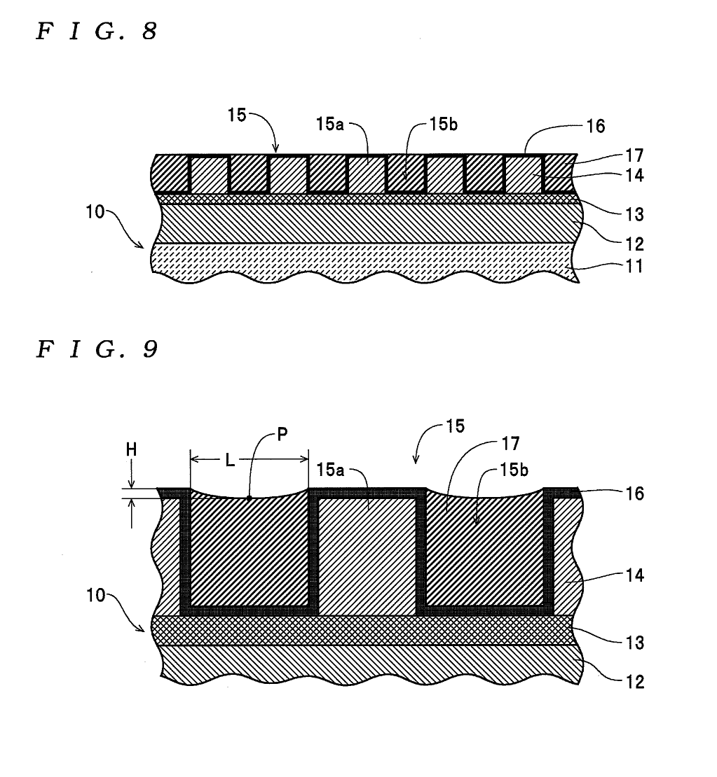

During the polishing process by the burnishing device 30, the state is maintained in which the rollers 32 pressing the burnishing tapes 31 against the resin layers 17 are continuously rotated at a very low speed while the workpiece 10 (resin layers 17) is rotated by the rotating mechanism in the direction indicated by the arrow R1. As a result, the respective surfaces of the burnishing tapes 31, having the abrasive attached thereto, are caused to rub against the surfaces of the resin layers 17, and as shown in FIG. 6, the surfaces of the resin layers 17 are plastically deformed while being ground. In doing this, the rollers 32 are continuously rotated at a low speed in the direction indicated by the arrow R2, to thereby prevent the burnishing tapes 31 from being clogged with cuttings from the resin layers 17. Further, the portions of the surfaces of the resin layers 17 are polished plural times, as required. Thus, as shown in FIG. 8, the protective film 16 on the protruding end face of each convex portion 15a is exposed from the resin layer 17, whereby the opposite surfaces of the workpiece 10 (the surfaces formed with the concave/convex pattern 15) are planarized.

In doing this, as shown in FIG. 9, a time period required for planarizing the resin layer 17 (time period over which the polishing process is continued) is adjusted as required, whereby the resin layer 17 is polished such that, within the concave/convex pattern 15, the level of at least a central portion P of the surface of the resin layer 17 becomes slightly lower than the level of the protective film 16 on each convex portion 15a. More specifically, the polishing process is executed until the level of the central portion P of the surface of the resin layer 17 within the concave portion 15b (non-recording area in the present invention) having a radial length L of approximately 50 nm becomes lower than the level of the surface of the protective film 16 by a height H (approximately 0.5 nm to 2 nm). In this case, since the protruding end face of each convex portion 15a is covered with the protective film 16, the convex portion 15a is prevented from being polished by the burnishing tape 31. Thus, an area where the concave portion 15b is formed (non-recording area) forms a recess the central portion P of which has a level slightly lower than the level of an area where the convex portion 15a is formed (recording area). This completes the polishing process as the planarizing process on the workpiece 10.

Then, the workpiece 10 (resin layer 17 embedded in each concave portion 15b) having been subjected to the planarizing process is irradiated with ultraviolet rays, whereby the opposite resin layers 17 are completely cured. In doing this, a time period over which ultraviolet rays are irradiated and the power of the ultraviolet rays are adjusted as required, to thereby sufficiently cure the resin layers 17. It should be noted that when a thermosetting resin material is used for forming the resin layers 17, the resin material (resin layers 17) is sufficiently cured by adjusting a time period over which heating process is carried out on the resin layers 17, and temperature at which the heating process is carried out, as required. Then, the opposite surfaces of the workpiece 10 are coated with the lubricant 18 by a dipping method. More specifically, after the workpiece 10 is dipped for 45 seconds in the lubricant 18 contained in a container, the workpiece 10 is pulled up from the container (lubricant 18) at a speed of 2.0 mm/sec. This completes the magnetic disk 1, as shown in FIG. 1.

In the magnetic disk 1, the surface of the non-recording area in the present invention is formed of an ultraviolet-curing resin having a bonding ratio higher than that of the DLC forming the protective film 16. Therefore, unlike the conventional magnetic recording medium over the whole area of which is formed a third non-magnetic film (thin film made of amorphous carbon), the adhesion of the lubricant 18 (a holding force for holding the lubricant 18) is high in the respective areas where the concave portion 15b of the concave/convex pattern 15 are formed, so that the adhesion of the lubricant 18 per predetermined area is increased (due to areas whose uppermost surfaces are formed of the resin layers 17). In this case, the respective bonding ratios of the protective film 16 (DLC) and the resin layer 17 (ultraviolet-curing resin) were measured according to the following conditions:

First, two first samples were made, each of which had a thin film (protective film 16) of DLC formed over the whole area of a support having a diameter of approximately 48 mm under the same conditions as conditions for forming the protective film 16, and two second samples were made, each of which had a layer (resin layer 17) of an ultraviolet-curing resin formed over the whole area of a support having a diameter of approximately 48 mm under the same conditions as conditions for forming the resin layer 17. Then, the lubricant 18 was applied to each sample by the dipping method. In this case, conditions for applying the lubricant 18 were as follows:

Lubricant: “Fomblin Z15” (available from Ausimont, K.K.)

Solvent: “Vertrel XF” (available from DU PONT-MITSUI FLUOROCHEMICALS COMPANY,LTD.)

Lubricant Concentration: 0.05 wt %

Dipping Time Period: 45 seconds

Pulling-up Speed: 2.0 mm/sec

Then, one of the first samples and one of the second samples were washed (rinsed). More specifically, the two samples were dipped in a container containing the above solvent. In doing this, the dipping time period and the pulling-up speed were set such that they were identical to those for dipping the lubricant 18. Then, each sample was measured by ESCA (Electron Spectroscopy for Chemical Analysis), whereby the ratio between the peak values of fluorine (ratio between area integrated intensities of F1s spectra after background correction) (peak value of fluorine in a washed sample/peak value of fluorine in an unwashed sample) was calculated as a bonding ratio. It should be noted that in the illustrated example, the ratio between the peak values of fluorine is calculated as “the ratio between average thicknesses of the lubricant”. As a result, the bonding ratio of the first sample (i.e., the protective film 16), and the bonding ratio of the second sample (i.e., the resin layer 17) were calculated to be 65% and 90%, respectively.

As described above, according to the magnetic disk 1, the recording area in the present invention is formed such that the protective film 16 formed of the protective film-forming material (DLC, in the illustrated example) exists above the recording area-forming material (recording layer-forming material, in the illustrated example) in the present invention, and at least a surface-side portion of the non-recording area in the present invention is formed of the non-recording area-forming material (resin material, in the illustrated example) whose bonding ratio with respect to the lubricant 18 is higher than the bonding ratio of the protective film-forming material with respect to the lubricant 18, whereby compared with the conventional magnetic recording medium over the whole area of which is formed the third non-magnetic film (amorphous carbon) having a lower bonding ratio with respect to the lubricant, it is possible to enhance the bonding ratio per predetermined area of the magnetic disk 1 with respect to the lubricant 18, since there exist areas (areas where the concave portions 15b are formed respectively) in which the resin layer 17 having a higher bonding ratio with respect to the lubricant 18 is exposed at the surface thereof. Therefore, the adhesion of the lubricant 18 (the holding force for holding the lubricant 18) is sufficiently enhanced over the whole magnetic disk 1, so that when the magnetic disk 1 is rotated at a high speed, it is possible to prevent the lubricant 18 from being lost by being scattered around the magnetic disk 1, or from being lost by being transferred from the surface of the magnetic disk 1 to the bottom surface of the magnetic head (slider) in a recording and reproducing device incorporating the magnetic disk 1. This makes it possible to maintain the capability of protecting both the magnetic disk 1 and the magnetic head for a long term.

In this case, in the magnetic disk 1 having the concentric or helical data recording tracks, there exist a large number of areas (non-recording areas formed of a resin material as a non-recording area-forming material) having a high bonding ratio with respect to the lubricant 18 in a radial direction thereof. This makes it possible to enhance the capability of holding the lubricant 18, which is about to be moved toward the outer periphery of the magnetic disk 1 by a centrifugal force generated by the high-speed rotation of the magnetic disk 1, at respective locations of the surface of the magnetic disk 1. As described above, when a large number of areas formed of a non-recording area-forming material exist in the radial direction of the magnetic disk 1, the effect in preventing the lubricant from being scattered during the high-speed rotation of the magnetic disk 1 becomes marked.

Further, according to the magnetic disk 1, a material mainly composed of carbon is used as the protective film-forming material in the present invention, and a resin material is used as the non-recording area-forming material in the present invention, whereby it is possible to reliably protect the recording layer 14 for a long term by the protective film 16 formed of the material which is mainly composed of carbon and has a sufficient hardness and a low aging rate, and cause a sufficient amount of the lubricant 18 to adhere to areas where the resin layer 17 is formed which has a high bonding ratio with respect to the lubricant 18, and can be easily machined. This makes it possible to protect both the magnetic disk 1 and the magnetic head from being damaged for a long term.

Furthermore, according to the magnetic disk 1, the level of at least the central portion P of the non-recording area (area where the concave portion 15b is formed) in the present invention is formed to be lower than the level of the recording area (area where the convex portion 15a is formed) in the present invention, whereby it is possible to reliably prevent the surface of the resin layer 17, which is not covered with the protective film 16, from being damaged by contact with the magnetic head. Further, this makes it possible to properly store a sufficient amount of the lubricant 18 in the non-recording area (area where the concave portion 15b is formed) whose level is lower than that of the recording area (the surface of the protective film 16).

It should be noted that the present invention is by no means limited to the above-described configurations and methods. For example, although the description has been given of the magnetic disk 1 in which the protruding end face and the side surface of each convex portion 15a of the concave/convex pattern 15, and the bottom surface of each concave portion 15b of the concave/convex pattern 15 are continuously covered with the protective film 16, this is not limitative, but the information medium according to the present invention can be configured, for example, such that when a concave/convex pattern is formed on a substrate (the workpiece 10) prior to the aforementioned resin layer-forming process, a protective film is formed in a manner covering only the protruding end of each convex portion of the formed concave/convex pattern. In the case where this configuration is employed when a concave/convex pattern is formed on a substrate in the present invention, for example, a protective film is formed on a surface of the substrate where the concave/convex pattern is formed, and the protective film and the substrate are etched using a mask pattern formed on the protective film, whereby the concave/convex pattern is formed which has the protruding end of each convex portion thereof covered with the protective film.

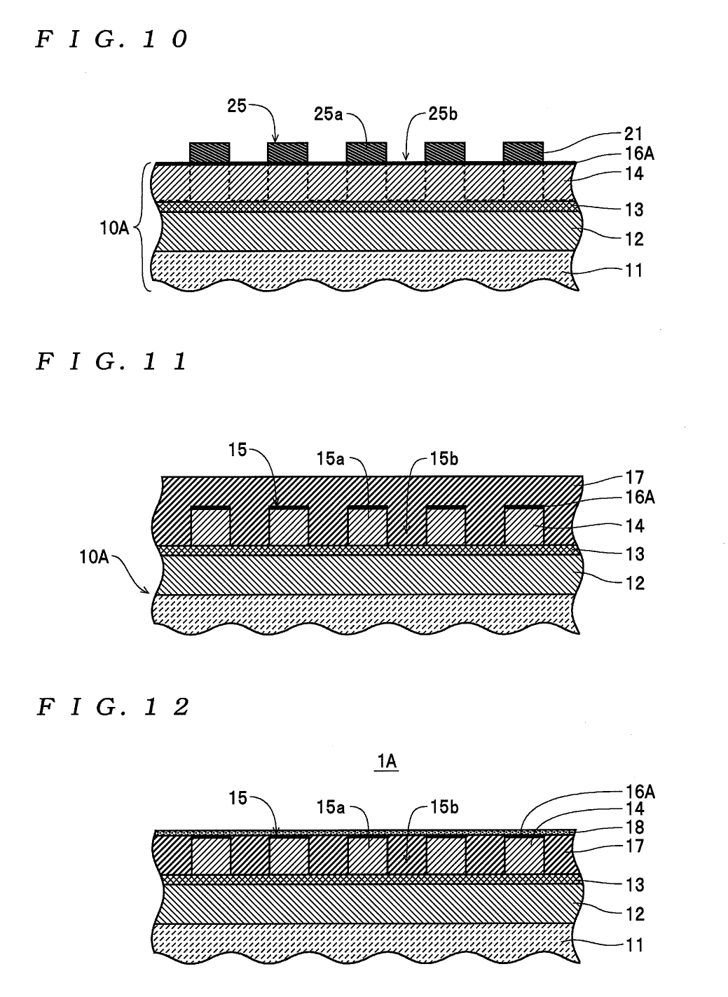

More specifically, e.g., as shown in FIG. 10, first, the concave/convex pattern 25 is formed on a workpiece 10A which has a protective film 16A formed in a manner covering the recording layer 14, and the protective film 16A is etched using the concave/convex pattern 25 (metal mask layer 21) as a mask pattern. Then, the recording layer 14 is etched. In doing this, there is employed any of a method of etching the recording layer 14 using the concave/convex pattern 25 used for etching the protective film 16A as a mask (a method of etching both the protective film 16A and the recording layer 14 using the concave/convex pattern 25 as a mask), a method of etching the recording layer 14 using the protective film 16A as a mask after selectively eliminating the concave/convex pattern 25 after completion of the etching of the protective film 16A, and a method of etching the recording layer 14 using the concave/convex pattern 25 as a mask, and etching the recording layer 14 using the protective film 16A exposed from the metal mask layer 21 after elimination of the concave/convex pattern 25 (metal mask layer 21).

Further, when etching of the recording layer 14 is completed, if the metal mask layer 21 remains on the protective film 16A, the metal mask layer 21 is selectively etched for elimination. This forms the concave/convex pattern 15 in the recording layer 14 (not shown). In this state, only the protruding end face of each convex portion 15a of the concave/convex pattern 15 is covered with the protective film 16A (see FIG. 11).

Then, as shown in FIG. 11, the resin layer 17 is formed on the concave/convex pattern 15 having convex portions 15a whose protruding end faces are covered with the protective film 16A. More specifically, for example, an ultraviolet-curing resin material is applied by the spin coating method on a surface of the workpiece 10 on which the concave/convex pattern 15 is formed. Then, the resin layer 17 on the workpiece 10A is irradiated with ultraviolet rays to half-cure the resin layer 17, and thereafter, the surface of the resin layer 17 is polished e.g., by the burnishing device 30 to thereby planarize the surface of the workpiece 10A (to perform the polishing process as the planarizing process). After completion of the planarizing process, the workpiece 10A (resin layer 17 embedded in each concave portion 15b) for which the planarizing process has been completed is irradiated with ultraviolet rays to thereby completely cure the resin layer 17. Subsequently, the lubricant 18 is applied to opposite surfaces of the workpiece 10A, whereby a magnetic disk 1A is completed as shown in FIG. 12.

As described above, also by the method of forming the resin layer 17 on the workpiece 10A in the state in which only the protruding end face of each convex portion 15a is covered with the protective film 16A, without forming the protective film 16 in a manner covering the whole area of the concave/convex pattern 15, it is possible to sufficiently prevent not only the resin layer 17 (resin material) but also the recording layer 14 (each convex portion 15a) from being polished during the planarizing process on the resin layer 17. Further, also in the magnetic disk 1A made by such a manufacturing method, similarly to the above-described magnetic disk 1, the adhesion of the lubricant 18 (the holding force for holding the lubricant 18) of the whole magnetic disk 1A is sufficiently enhanced, since the non-recording area exists at which the resin layer 17 having a high bonding ratio with respect to the lubricant 18 is exposed.

Further, although in the methods of manufacturing the magnetic disks 1 and 1A, the method is employed in which the resin layer 17 is polished and planarized by rubbing the burnishing tape 31 (polishing member) against the surface of the half-cured resin layer 17 to cut away (grind) the resin layer 17, the term “polishing” is intended, throughout the specification, to mean processing for plastically deforming the resin layer 17 e.g., by rubbing a plate-shaped member against the surface of the resin layer 17 in a half-cured or uncured state, and processing for executing both plastic deformation and grinding of the resin layer 17 in parallel. More specifically, for example, it is possible to employ a method of planarizing the resin layer 17 by causing the burnishing tape 31 to rub against the resin layer 17 (resin material) in the uncured state for plastic deformation, and grinding the resin layer 17, and a method of planarizing the resin layer 17 by causing a plate-shaped member, such as a scraper, not shown, to rub against the resin layer 17 (resin material) in the uncured state for plastic deformation. In this case, the term “uncured state” is intended to mean a state in which the applied resin material has not been irradiated with radiation in the case where a radiation-curing resin is used as the resin material, and a state in which heating process has not been executed on the applied resin material in the case where a thermosetting resin is used as the resin material. In short, a state in which the resin layer is very slightly cured by application of illuminating light or room temperature during a time period from during execution of the resin layer-forming process to a time point when the planarizing process is started, is also included in “the uncured state”.

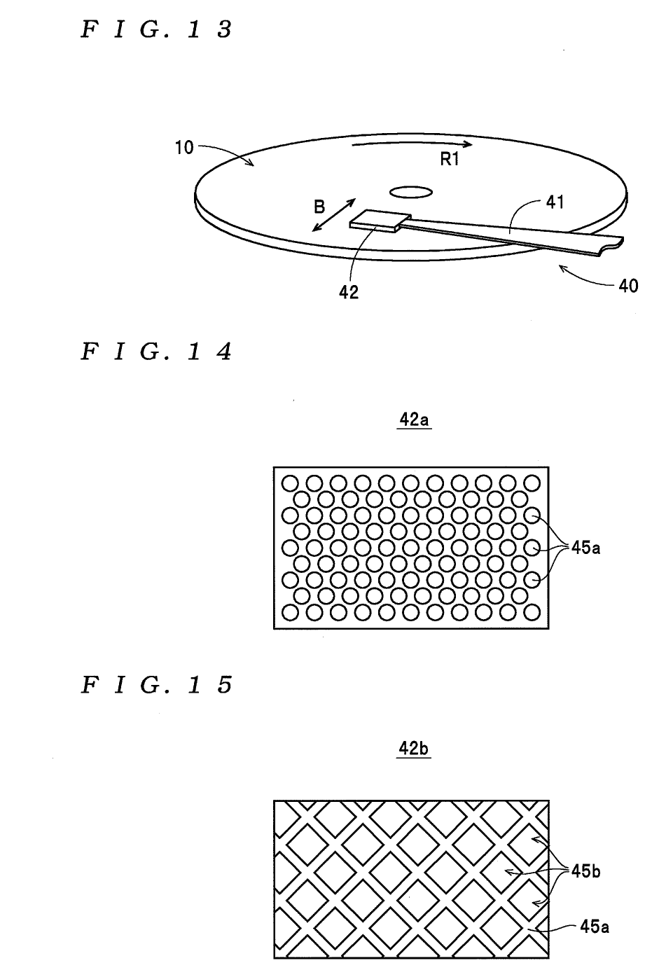

Furthermore, it is also possible to employ a method of polishing the resin layer 17 using a burnishing device 40 shown in FIG. 13 in place of the burnishing device 30. The burnishing device 40 is comprised of a rotating mechanism, not shown, for rotating the workpiece 10 and the like formed with the resin layer 17, in the direction indicated by an arrow R1, and a swing arm 41 for causing a burnishing head 42 mounted to a foremost end thereof to operate in a direction indicated by an arrow B on the workpiece 10 (on the resin layer 17). It should be noted that the burnishing head 42 has a bottom surface thereof formed with plural convex portions having an abrasive attached thereto, or plural convex portions formed of an abrasive, and is configured such that it can polish the resin layer 17 when a protruding end face of each of these convex portions is caused to rub against the resin layer 17. More specifically, it is possible to use a burnishing head 42a which has plural convex portions 45a each having a circular protruding end face as shown in FIG. 14, and a burnishing head 42b which has plural concave portions 45b divided by lattice-shaped convex portions 45a as shown in FIG. 15.

Further, a dry polishing member for planarizing the resin layer 17 is not limited to the burnishing tape 31 and the burnishing head 42, but it is possible to carry out the polishing process as the planarizing process by using dry polishing members, such as abrasive paper, abrasive cloth, and grindstone, in place of the burnishing tape 31 and the burnishing head 42. Further, although the description has been given of the method in which the surface of the workpiece 10 is planarized by grinding the surface of the resin layer 17 for plastic deformation during the polishing process, the polishing process as the planarizing process for planarizing the resin layer 17 is not limited to this, but it is possible to employ a method of planarizing the surface of the workpiece 10 without plastically deforming the same, by completely or almost completely curing the resin layer 17 prior to the polishing process, and cutting away (grinding) the surface of the resin layer 17 by a grinding process as the polishing process (planarizing process). Further, it is also possible to employ a method of planarizing the surface of the workpiece 10 by a polishing process using the CMP method and a dry etching method, in place of the planarizing method using the burnishing devices 30 and 40.

Further, although in the above-described magnetic disks 1 and 1A, the resin material is employed as the non-recording area-forming material in the present invention, this is not limitative, but in place of the resin material, various kinds of non-magnetic materials including oxides, such as SiO₂ and Al₂O₃, and carbides, such as SiC and AlTiC, can be employed as the non-recording area-forming material.

Furthermore, although in the above-described magnetic disk 1, the whole of each convex portion 15a of the concave/convex pattern 15, from a protruding end (front surface side of the magnetic disk 1) to a root portion thereof, is formed of the recording layer 14 (magnetic material), the construction of the information media manufactured according to the information medium of the present invention is not limited to this. More specifically, for example, when the recording layer 14 is etched using the concave/convex pattern 25 (mask pattern), by reducing an etching amount of the recording layer 14 to a certain degree (the concave portions 15b formed are made shallower), it is possible form a magnetic disk, not shown, on which not only the convex portions 15a (recording areas) but also the concave portions 15b (non-recording areas) including their bottoms are formed from the recording layer 14.

Further, when the recording layer 14 is etched using the concave/convex pattern 25, by increasing the etching amount of the recording layer 14 to a certain degree (the concave portions 15b formed are made deeper), it is possible to form a magnetic disk, not shown, having a concave/convex pattern 15 formed thereon, which has plural convex portions 15a (recording areas) each having only a protruding end thereof (front surface side of the magnetic recording medium) formed of the recording layer 14, and a root portion thereof formed of a non-magnetic material or a soft magnetic material. Furthermore, for example, it is possible to form a magnetic disk by forming the above-described concave/convex pattern 25 on the disk-shaped base plate 11, forming a concave/convex pattern (concave/convex pattern similar to the concave/convex pattern 15 in the concave-convex positional relationship: not shown) on the disk-shaped base plate 11 by etching the disk-shaped base plate 11 using the concave/convex pattern 25 as a mask pattern, forming a thin recording layer 14 according to the formed concave/convex pattern, to thereby form a layer below the recording layer 14 of the concave/convex pattern, and form the recording layer 14 of the concave/convex pattern according to the layer, and forming a concave/convex pattern 15 formed thereon, which has plural convex portions 15a (recording areas) surfaces of which are covered with a magnetic material (recording layer 14), and plural concave portions 15b (non-recording areas) bottom surfaces of which are formed of a magnetic material (recording layer 14).

Further, the information media according to the present invention are not limited to magnetic recording media, such as the magnetic disk 1 based on the perpendicular recording method, but they can also be applied to magnetic recording media based on a longitudinal recording method. Moreover, although in the above-described magnetic disk 1, plural concentric or helical data recording tracks are formed, this is not limitative, but the configuration of the information media according to the present invention includes a patterned medium in which recording areas forming the data recording tracks are separated from each other in a manner sandwiching the associated non-recording areas in the circumferential direction of the magnetic recording medium.

What is claimed is:

1. An information medium configured such that a recording area and a non-recording area are arranged on at least one surface of a substrate, and a lubricant exists on the one surface,
wherein the recording area is configured such that a protective film formed of a protective film-forming material exists above a recording area-forming material, and
wherein at least a surface-side portion of the non-recording area is formed of a non-recording area-forming material having a bonding ratio with respect to the lubricant higher than that of the protective film-forming material.

2. An information medium according to claim 1, wherein the protective film-forming material is mainly composed of carbon, and the non-recording area-forming material is formed of a resin material.

3. An information medium according to claim 1, wherein the non-recording area is formed such that at least a level of a central portion thereof is lower than a level of the recording area.

4. An information medium according to claim 2, wherein the non-recording area is formed such that at least a level of a central portion thereof is lower than a level of the recording area.
